(19) United States
(12) Patent Application Publication
(10) Pub. No.: US 2002/0192420 A1
(43) Pub. Date: Dec. 19, 2002

(54) Reflecting cloth with a preferred reflecting effect

(76) Inventor: Gung Bo Shu, Chang-Hua City (TW)

Correspondence Address: GUNG BO SHU, PO BOX 487, Chang-Hua City, 500, TW

(21) Appl. No.: 10/137,296

(22) Filed: May 3, 2002

(30) Foreign Application Priority Data
Jun. 14, 2001 (TW) 090209950

(51) Int. Cl. B32B 3/00; B32B 5/02; B32B 27/04; B32B 27/12

(52) U.S. Cl. 428/59

(57) ABSTRACT

A reflecting cloth with a preferred reflecting effect has a cloth lower layer (or tape layer), a plating metal film middle layer, and a fine glass upper layer. Since the plating metal film is smooth and reflect light so that the light can be reflected to the fine glass beads to generate cloth (or tape) with light of various colors. The plating metal film middle layer is plated on a tape. The plating metal film middle layer has textures so as to enhance the reflecting effect.

### BACKGROUND OF THE INVENTION

1. Field Of The Invention

The present invention relate to reflecting cloth, and particularly to reflecting cloth having a preferred reflecting effect.

2. Description of The Related Art

The prior art reflecting cloth is formed by a cloth layer, a silver layer, and a fine glass upper layer. By the silver layer to reflect light to the fine glass upper layer so as to present a sparkle effect. However, this kind of reflecting cloth has only one color and thus the reflecting effect will be reduced.

### SUMMARY OF THE INVENTION

Accordingly, the primary object of the present invention is to provide a reflecting cloth with a preferred reflecting effect. The reflecting cloth has a cloth lower layer (or tape layer), a plating metal film middle layer, and a fine glass upper layer. Since the plating metal film is smooth and reflects light so that the light can be reflected to the fine glass beads to generate cloth (or tape) with light of various colors The plating metal film middle layer is plated on a tape. The plating metal film middle layer has textures so as to enhance the reflecting effect.

The various objects and advantages of the present invention will be more readily understood from the following detailed description when read in conjunction with the appended drawing.

### BRIEF DESCRIPTION OF THE DRAWINGS

FIG. 1 shows the structure of a prior art reflecting cloth.

FIG. 2 shows the structure of the reflecting cloth of the present invention.

FIG. 3 shows the reflection effect of a prior reflecting cloth.

FIG. 4 shows the reflection effect of the reflecting cloth of the present invention.

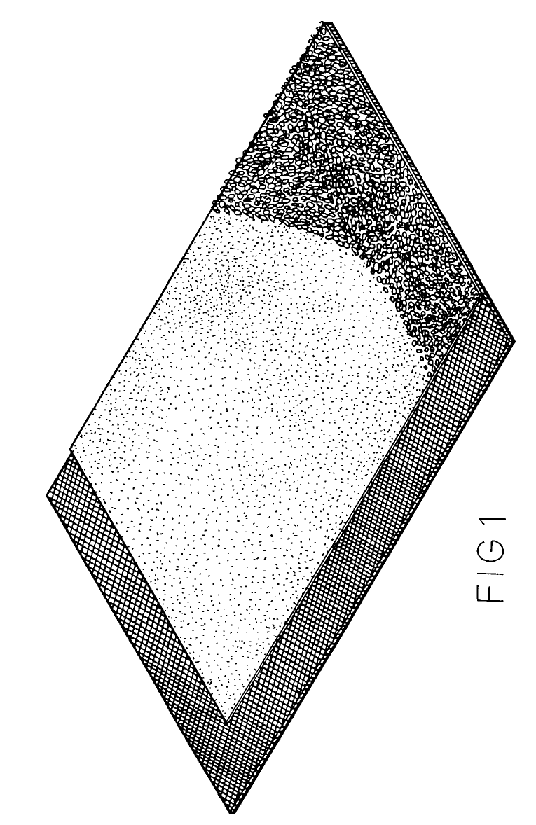

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

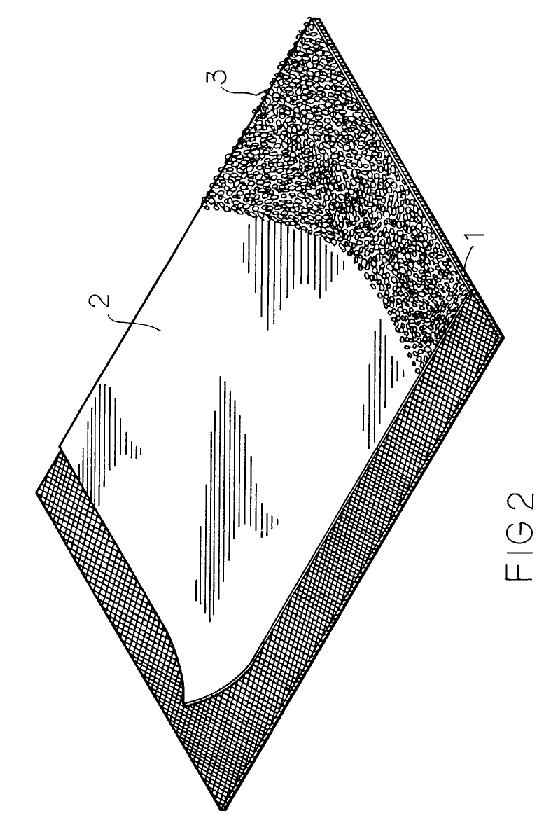

Referring to FIG. 2, the present invention has a cloth lower layer 1 (or tape layer), a plating metal film middle layer 2, and a fine glass upper layer 3, etc. By this structure, a cloth (or tape) with preferred reflecting effect can be acquired. The lower layer 1 is stuck to the plating metal film middle layer 2 so as to form a substrate. Then a layer of fine glass beads is stuck to this substrate. Since the plating metal film is smooth and can reflect light so that the light can be reflected to the fine glass beads so as to generate cloth (or tape) with light of various colors.

Moreover, above said plating film may be a plating film with any color. The color of the plating film can be changed as desired so as to acquire reflecting cloth of various colors.

The plating metal film middle layer may have textures so as to enhance the reflecting effect.

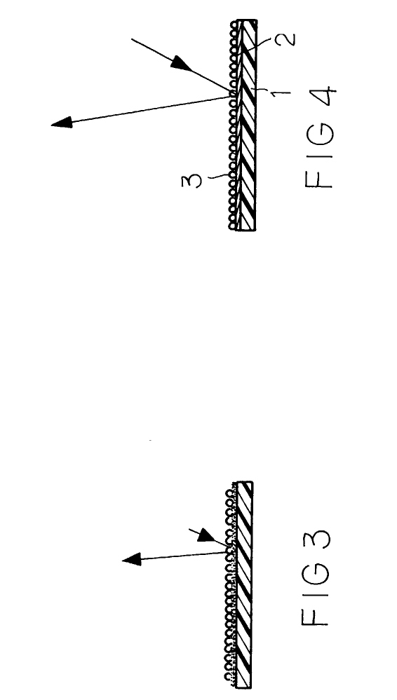

Moreover, referring to FIG. 3, prior art reflecting cloth is illustrated. The middle layer of the reflecting layer is silver powders or paint. The surface of the middle layer is not flat. The reflecting light from the silver middle layer passes through the glass beads so as to have shorter wavelength.

With reference to FIG. 4, a representation for the reflected light of the reflecting cloth is illustrated. The plating metal film layer has a smooth surface so that light with longer wavelength can be reflected. When light with multiple wavelengths is reflected from the layer, reflecting light with sparkle effect like that from a diamond is illustrated.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A reflecting cloth with a preferred reflecting effect; the reflecting cloth having a cloth lower layer (or tape layer), a plating metal film middle layer, and a fine glass upper layer; since the plating metal film is smooth and reflect light so that the light is reflected to the fine glass beads to generate cloth (or tape) with light of various colors.

2. The reflecting cloth as claimed in claim 1, wherein the plating metal film middle layer is plated on a tape.

3. The reflecting cloth as claimed in claim 1, wherein the plating metal film middle layer has textures so as to enhance the reflecting effect.
